(19) United States
(12) Patent Application Publication
(10) Pub. No.: US 2010/0215286 A1
(43) Pub. Date: Aug. 26, 2010

(54) IMAGE PROCESSING APPARATUS AND IMAGE PROCESSING METHOD

(76) Inventor: Masaru Takahashi, Fukaya-shi (JP)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/635,522

(22) Filed: Dec. 10, 2009

(30) Foreign Application Priority Data
Feb. 25, 2009 (JP) 2009-042706

(51) Int. Cl. G06K 9/40

(52) U.S. Cl. 382/274

(57) ABSTRACT

According to one embodiment, an image processing apparatus includes a detector configured to detect a difference value between frames included in image data, a sharpening parameter setting module configured to set a sharpening parameter for controlling a sharpening effect gain for the image data in accordance with the detected difference value, and a sharpening processor configured to perform a sharpening process to the image data based on the sharpening parameter.

### CROSS-REFERENCE TO RELATED APPLICATIONS

This application is based upon and claims the benefit of priority from Japanese Patent Application No. 2009-042706, filed Feb. 25, 2009, the entire contents of which are incorporated herein by reference.

### BACKGROUND

1. Field

One embodiment of the invention relates to an image processing apparatus and an image process method, which execute a sharpening process for sharpening an image, and an image processing apparatus which executes a coring process for reducing a noise component of an image.

2. Description of the Related Art

In recent years, there have been an increasing number of opportunities of viewing/listening to video content by a display for a personal computer which has a resolution exceeding SD (Standard Definition) specifications. In addition, the performance of printers has been improved, and high-density printing has been enabled. Moreover, with the full-scale implementation of high-vision broadcasting, TV receivers which support the HD (High Definition) standard are gaining in popularity in general homes.

Compared to output apparatuses having such high resolution, the video data acquired by imaging devices, such as video cameras, and TV broadcast and DVDs of the SD standard have low resolution. It is necessary, therefore, to increase the resolution by some means. In addition, it is necessary to enhance the resolution in the case where part of video or image is to be enlarged, or in the case where photographing is performed by using a video camera with a digital zoom exceeding the level of an optical zoom.

Conventionally, in the resolution enhancement, use has been made of linear interpolation, or interpolation by cubic convolution. However, there is a problem that sufficient sharpness cannot be obtained. Jpn. Pat. Appln. KOKAI Publication No. 2008-067110 and Jpn. Pat. Appln. KOKAI Publication No. 2008-146190 disclose super-resolution techniques wherein an image with a resolution higher than the resolution of original image data is generated by generating new pixel value data between pixels, and creating a high frequency component, thereby sharpening an image. Besides, a technique for incorporating the super-resolution function in the above-described video input/output apparatus has been developed.

However, it has turned out that in the case where such a sharpening process is implemented in an actual output apparatus such as a digital TV, the image quality may lower by the sharpening process, depending on the condition of images. For example, in some cases, block noise, which frequently occurs in input source images with large frame differences, may be emphasized by the sharpening process. Similarly, in some cases, noise may be emphasized by a coring process.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a view which schematically shows the structure of an image processing apparatus according to an embodiment of the invention;

FIG. 2 shows an example of a weighting process for weighting on a histogram distribution of frame differences;

FIG. 3 is a graph showing an example of input/output conversion for acquiring a correction parameter for controlling the effect of a super-resolution coring process;

FIG. 4 is a graph showing an example of input/output conversion for acquiring a correction parameter for controlling the effect of an image sharpening process;

FIG. 5 is a flow chart illustrating an example of an image quality degradation preventing process for varying and controlling the effects of the super-resolution coring process and image sharpening process;

FIG. 6 is a view which schematically shows an example of the structure of a TV signal receiving apparatus according to the embodiment, in which the image processing apparatus shown in FIG. 1 is incorporated;

FIG. 7 is a view which schematically shows an example of the structure of a super-resolution coring processor; and

FIG. 8 is a view which schematically shows an example of the structure of a vertical noise reducing circuit (coring process circuit).

### DETAILED DESCRIPTION

Various embodiments according to the invention will be described hereinafter with reference to the accompanying drawings. In general, an image processing apparatus according to one embodiment of the invention comprises a detector configured to detect a difference value between frames included in image data; a sharpening parameter setting module configured to set a sharpening parameter for controlling a sharpening effect gain for the image data in accordance with the detected difference value; and a sharpening processor configured to apply a sharpening process to the image data based on the sharpening parameter.

An embodiment of the present invention will now be described with reference to the accompanying drawings.

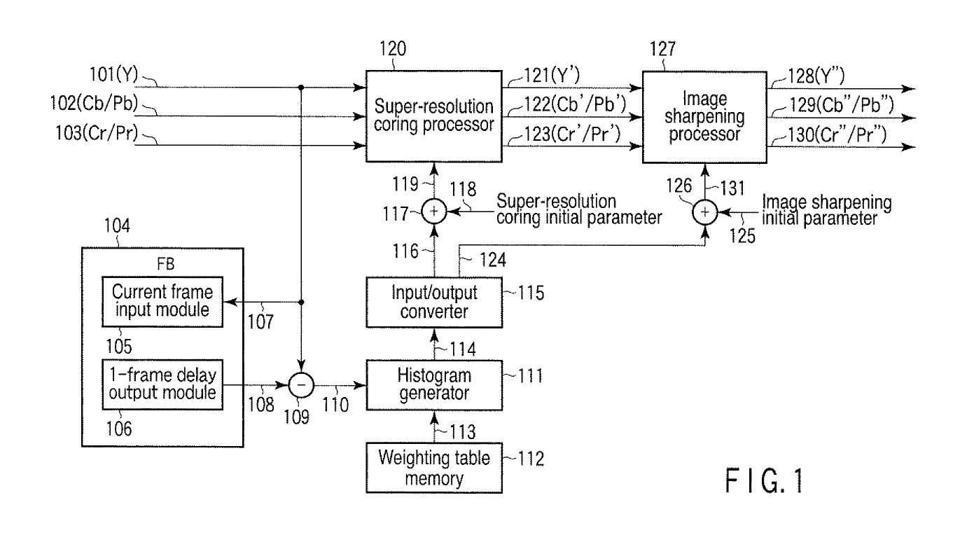

FIG. 1 is a view which schematically shows the structure of an image processing apparatus according to an embodiment of the invention. As shown in FIG. 1, the image processing apparatus comprises a frame buffer 104, a subtracter 109, a histogram generator 111, a weighting table memory 112, an input/output converter 115, adders 117 and 126, a super-resolution coring processor 120, and an image sharpening processor 127.

Input video signals 101 (luminance: Y), 102 (color signal: Cb/Pb) and 103 (color signal: Cr/Pr) are input to the super-resolution coring processor 120. The input video signal 101 (luminance: Y) is input to the frame buffer 104 and subtracter 109. The super-resolution coring processor 120 executes a super-resolution coring process. The super-resolution coring process, in this context, refers to a process of suppressing a noise component which may occur due to a super-resolution process. The frame buffer 104 includes a current frame input module 105 and a 1-frame delay output module 106. A luminance signal of a current frame is input to the current frame input module 105, and the 1-frame delay output module 106 outputs a luminance signal of a delay frame which is delayed by 1 frame relative to the current frame. Thereby, the subtracter 109 outputs a difference value 110 between the luminance signal of the current frame and the luminance signal of the delay frame.

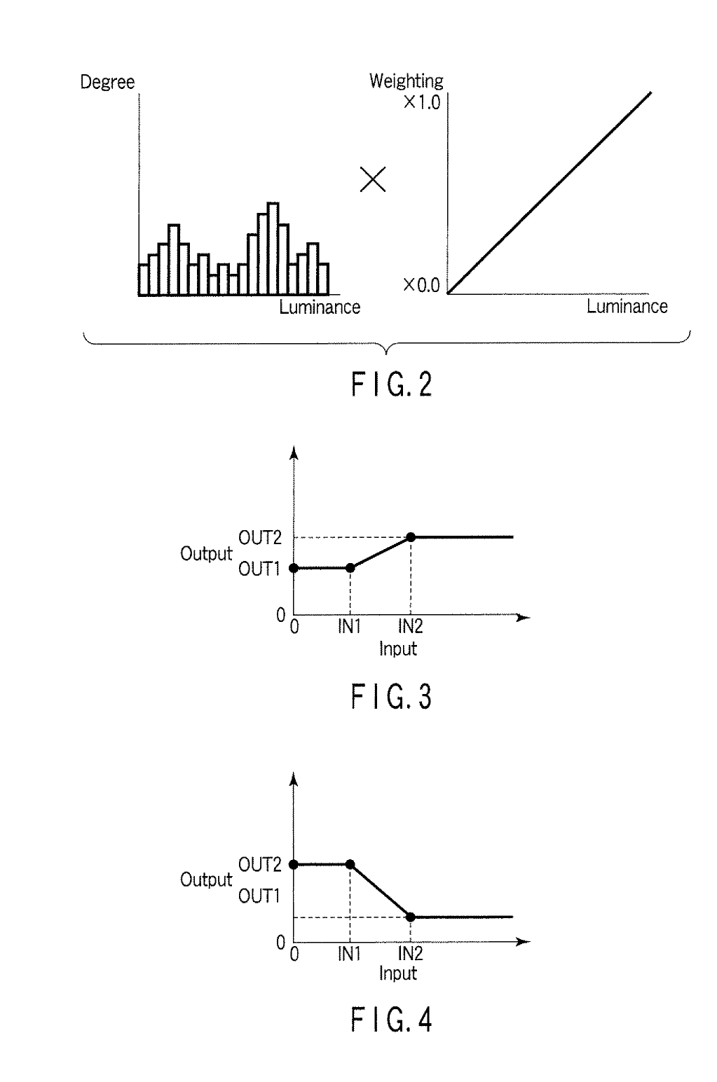

The histogram generator 111 generates a histogram distribution (see FIG. 2) which is indicative of frame differences, on the basis of the difference value 110.

FIG. 2 shows an example of a weighting process for weighting on the histogram distribution. As shown in FIG. 2, the histogram generator 111 multiplies the degrees of levels of the histogram distribution by weighting coefficients which are set for the respective levels, acquires a sum of the degrees of all levels, calculates a frame difference value between a current frame and a delay frame, and outputs the frame difference value to the input/output converter 115.

The input/output converter 115 outputs to the adder 117 a first correction parameter (offset data) 116 corresponding to the difference value, and outputs to the adder 126 a second correction parameter (offset data) 124 corresponding to the difference value. The input/output converter 115 may output a corrected first correction parameter 116 or a corrected second correction parameter 124 so that the first correction parameter 116 or second correction parameter 124 may not vary abruptly or frequently.

The adder 117 adds a super-resolution coring initial parameter 118 and the first correction parameter 116 and generates a super-resolution coring parameter 119. The adder 117 outputs the super-resolution coring parameter 119 to the super-resolution coring processor 120. Specifically, the adder 117 sets the super-resolution coring parameter 119, which is corrected in accordance with the difference value, to the super-resolution coring processor 120.

The adder 126 adds an image sharpening initial parameter 125 and the second correction parameter 124 and generates an image sharpening parameter 131. The adder 126 outputs the image sharpening parameter 131 to the image sharpening processor 127. Specifically, the adder 126 sets the image sharpening parameter 131, which is corrected in accordance with the difference value, to the image sharpening processor 127.

Thereby, the super-resolution coring processor 120 can control the super-resolution coring effect in accordance with the difference value. In other words, the super-resolution coring processor 120 can enhance the super-resolution coring effect in accordance with the increase of the difference value. Thereby, deterioration of MPEG noise can be prevented, and the user can enjoy video in which a proper super-resolution coring process has been applied to an input image.

In addition, the image sharpening processor 127 can control the image sharpening effect in accordance with the difference value. In other words, the image sharpening processor 127 can reduce the image sharpening effect in accordance with the increase of the difference value. Thereby, deterioration of MPEG noise can be prevented, and the user can enjoy video in which a proper image sharpening process has been applied to an input image.

A supplementary description is given of the super-resolution process by the super-resolution coring processor 120 and the image sharpening processor 127. For example, the image sharpening processor 127 executes a sharpening process of restoring a high-resolution image signal with a second resolution, by estimating a prospective pixel value from a low-resolution image signal with a first resolution, and increasing the number of pixels. The “prospective pixel value”, in this context, refers to a value of each pixel of an image signal which is obtained, for example, when the same subject as was photographed when an image signal of a low resolution (first resolution) was obtained, is photographed by a camera of a high resolution (second resolution). In addition, the process of “estimating the prospective pixel value and increasing the number of pixels” means a process of estimating a prospective pixel value from an image having high correlativity in the same frame or between frames by capturing a feature of an object image, and obtaining a pixel value which is associated with a new pixel. In short, the correlativity of images is utilized.

To be more specific, to begin with, provisional full-HD high-resolution video is created from an original input video by an up-convert process. In other words, on the basis of the information of neighboring pixels, an intervening pixel is interpolated, and provisional full-HD high-resolution video is created. The interpolated pixel is not necessarily a pixel that is present in the original video. Specifically, noise or edge disturbance due to a calculation error may occur.

Subsequently, on the basis of a photographing model function, video, which is down-converted to the same resolution as the original video, is created from the provisional full-HD high-resolution video. The photographing model function is a function which reproduces, by calculation, the same process as the process of converting information of an imaging element to a video signal by an ordinary camera.

The down-converted video is theoretically the same as the original input video. However, for example, due to a calculation error in the up-convert process, a different part occurs between the down-converted video and the original input video. This different part is detected, and correction is made so as not to produce a calculation error with reference to the information of peripheral pixels, and thus output video, which has been subjected to a super-resolution process and has become closer to the original input video, is generated.

In short, the super-resolution process is a technique of restoring a signal, which the original input video should normally have, by comparing the down-converted video and the original input video. As the process of the comparison and restoration is repeated, the precision of the super-resolution process becomes higher. Accordingly, a process, in which the process of comparison and restoration is executed only once, is the super-resolution process, and also a process, in which the process of comparison and restoration is executed twice or more, is also the super-resolution process. In the case where there is time to spare, for example, in the case where recorded video is to be viewed later, it is possible to make use of the super-resolution process in which the process of comparison and restoration is repeated twice or more.

The super-resolution process of the present embodiment includes publicly known/publicly used techniques disclosed in, for instance, Jpn. Pat. Appln. KOKAI Publication No. 2007-310837, Jpn. Pat. Appln. KOKAI Publication No. 2008-98803 and Jpn. Pat. Appln. KOKAI Publication No. 2000-188680. As the super-resolution process of the present embodiment, use may be made of, for example, the technique of restoring an image having a frequency component which is higher than a Nyquist frequency which is determined by a sampling cycle of an input image.

For example, in the case where the super-resolution process disclosed in Jpn. Pat. Appln. KOKAI Publication No. 2007-310837 is used, a plurality of corresponding points corresponding to a plurality of pixel-of-interest regions, which are closest to variation patterns of pixel values in the pixel-of-interest regions including pixels-of-interest in a plurality of intermediate-resolution frames, are selected from a reference frame. Sample values of luminance at the corresponding points are set at the pixel values of the pixels-of-interest which correspond to the corresponding points. On the basis of the magnitudes of the plural sample values and the arrangement of the plural corresponding points, pixel values of a high-resolution frame, which has a greater number of pixels than the reference frame and which corresponds to the reference frame, are calculated. Thereby, prospective pixel values are estimated from a low-resolution image signal, and the number of pixels is increased. Thereby, a high-resolution image signal is restored.

In the case of using the super-resolution process disclosed in Jpn. Pat. Appln. KOKAI Publication No. 2008-98803 which makes use of a self-congruent position search within the same frame image, errors of respective pixels in search regions of intermediate-resolution frames are compared, and a first pixel position with a minimum error is calculated. On the basis of the first pixel position, a first error of the first pixel position, a second pixel position near the first pixel and a second error of the second pixel position, a position with a minimum error in the search region is calculated with the precision on the order of decimals. A decimal-precision vector having this position as an end point and a pixel-of-interest as a beginning point is calculated. Using this decimal-precision vector, an extrapolation vector of the decimal-precision vector, which has, as an end point, a pixel on the screen which is not included in the search region, is calculated. On the basis of the decimal-precision vector, the extrapolation vector and the pixel value obtained from the image signal, a pixel value of a high-resolution image having a number of pixels, which is greater than the number of pixels included in the image signal, is calculated. In the super-resolution process of the present embodiment, the prospective pixel value is estimated from the image signal of low resolution by the above-described process, and the number of pixels is increased. Thereby, a high-resolution image signal is restored.

Use may also be made of the super-resolution process disclosed in Jpn. Pat. Appln. KOKAI Publication No. 2000-188680, which makes use of mapping between frame images.

In the super-resolution process of the present embodiment, expanded video is once converted to low-resolution video by the application of a unique algorithm. In addition, the resultant video may be compared with the original input video, and a difference may be detected. By further executing a correction process for the difference, an image-quality-enhancing process may be executed.

The method of the super-resolution process of the present embodiment, however, is not limited to the above-described examples. By increasing the number of pixels by estimating prospective pixel values from a low-resolution image signal, a process of restoring a high-resolution image signal may be executed, or any other methods are applicable.

A further detailed description is given of the process of varying and controlling the effects of the super-resolution coring process and the image sharpening process.

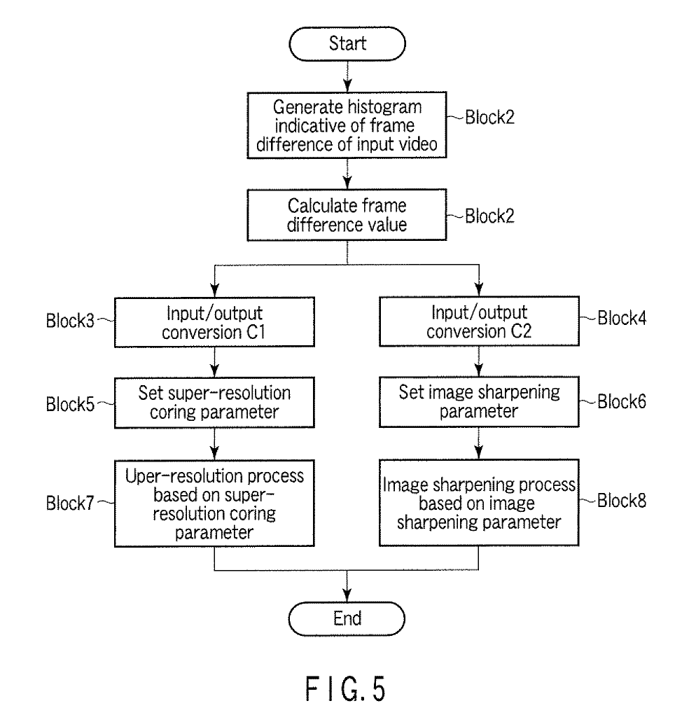

FIG. 5 is a flow chart illustrating an example of an image quality degradation preventing process for varying and controlling the effects of the super-resolution coring process and image sharpening process, in accordance with difference values. In the present embodiment, a description is given of the image quality degradation preventing process for varying and controlling the two processes, namely the super-resolution coring process and image sharpening process, in accordance with difference values. The present invention, however, is not limited to this process. For example, the image quality degradation preventing process, which is described below, may vary and control the effect of only one of the super-resolution coring process and image sharpening process in accordance with difference values. Besides, the image quality degradation preventing process, which is described below, is applicable to an image process other than the super-resolution coring process and image sharpening process.

As has been described above, the histogram generator 111 generates a histogram distribution which is indicative of frame differences (Block 1), executes a weighting process, etc., and calculates a frame difference value (Block 2). The input/output converter 115 executes input/output conversion C1, as shown in FIG. 3, in accordance with the frame difference value, and outputs a first correction parameter (Block 3). Similarly, the input/output converter 115 executes input/output conversion C2, as shown in FIG. 4, in accordance with the frame difference value, and outputs a second correction parameter 124 (Block 4).

FIG. 3 is a view showing an example of the input/output conversion C1 of Block 3. In the input/output conversion C1, a conversion function with two points of input/output threshold levels (threshold values) is adopted. As shown in FIG. 3, OUT1 is set for IN1, and OUT2 is set for IN2. The relationship between the input threshold level and output level, which is shown in FIG. 3, is merely an example, and this relationship can freely be varied in order to obtain the image quality degradation preventing effect.

As shown in FIG. 3, linear interpolation is executed for an input value between IN1 and IN2 (IN1 or more, and IN2 or less), thereby outputting a value transitioning from OUT1 to OUT2. In the case where the input value is less than IN1, OUT1 is always output. In the case where the input value is more than IN2, OUT2 is always output.

The value that is obtained by the input/output conversion C1 (Block 3) is output to the adder 117 as a first correction parameter (offset data) to the super-resolution coring processor 120. The adder 117 adds the super-resolution coring initial parameter 118 and the first correction parameter and generates the super-resolution coring parameter 119 (super-resolution coring offset parameter). The adder 117 outputs the super-resolution coring parameter 119 to the super-resolution coring processor 120 (Block 5).

Specifically, the super-resolution coring parameter 119, which is input to the super-resolution coring processor 120, is as follows:

(1) When a first difference value of less than IN1 is detected, a first super-resolution coring parameter 119 for obtaining a first coring effect is set.

(2) When a second difference value of more than IN2 is detected, a second super-resolution coring parameter 119 for obtaining a second coring effect, which is greater than the first coring effect, is set.

(3) On the basis of detection of a third difference value which is between IN1 and IN2, a third coring parameter is set. The third coring parameter is a parameter for obtaining a third coring effect which is greater than the first coring effect and less than the second coring effect, the third coring effect increasing in accordance with the increase of the third difference value.

Thereby, the super-resolution coring processor 120 can execute the super-resolution coring process corresponding to the variation of the difference value, on the basis of the super-resolution coring parameter 119 (super-resolution coring offset parameter) which is corrected in accordance with the variation of the difference value (Block 7). In short, in accordance with the increase of the difference value, the effect of the super-resolution coring can be increased, and the degradation in MPEG noise can be prevented. As shown in FIG. 1, the super-resolution coring processor 120 outputs video signals 121 (luminance: Y′), 122 (color signal: Cb′/Pb′) and 123 (color signal: Cr′/Pr′) which have been subjected to the super-resolution coring process and correspond to the input video signals 101, 102 and 103, respectively.

FIG. 4 is a view showing an example of the input/output conversion C2 of Block 4. In the input/output conversion C2, a conversion function with two points of input/output threshold levels (threshold values) is adopted. As shown in FIG. 4, OUT1 is set for IN1, and OUT2 is set for IN2. The relationship between the input threshold level and output level, which is shown in FIG. 4, is merely an example, and his relationship can freely be varied in order to obtain the image quality degradation preventing effect.

As shown in FIG. 4, linear interpolation is executed for an input value between IN1 and 1N2 (IN1 or more, and IN2 or less), thereby outputting a value transitioning from OUT1 to OUT2. In the case where the input value is less than IN1, OUT2 is always output. In the case where the input value is greater than IN2, OUT1 is always output.

The value that is obtained by the input/output conversion C2 (Block 4) is output to the adder 126 as a second correction parameter 124 to the image sharpening processor 127. The adder 126 adds the image sharpening initial parameter and the second correction parameter 124 and generates the image sharpening parameter 131 (image sharpening offset parameter). The adder 126 outputs the image sharpening parameter 131 to the image sharpening processor 127 (Block 6).

Specifically, the image sharpening parameter 131, which is input to the image sharpening processor 127, is as follows:

(1) When a first difference value of less than IN1 is detected, a first sharpening parameter for obtaining a first sharpening effect gain is set.

(2) When a second difference value of more than IN2 is detected, a second sharpening parameter for obtaining a second sharpening effect gain, which is less than the first sharpening effect gain, is set.

(3) When a third difference value which is between IN1 and IN2 is detected, a third sharpening parameter is set. The third sharpening parameter is a parameter for obtaining a third sharpening effect gain which is less than the first sharpening effect gain and greater than the second sharpening effect gain, the third sharpening effect gain decreasing in accordance with the increase of the third difference value.

Thereby, the image sharpening processor 127 can execute the image sharpening process corresponding to the variation of the difference value, on the basis of the image sharpening parameter 131 (image sharpening offset parameter) which is corrected in accordance with the variation of the difference value (Block 8). In short, in accordance with the increase of the difference value, the image sharpening gain can be decreased, and the degradation in MPEG noise can be prevented. As shown in FIG. 1, the image sharpening processor 127 outputs video signals 128 (luminance: Y″), 129 (color signal: Cb″/Pb″) and 130 (color signal: Cr″/Pr″) which have been subjected to the image sharpening process and correspond to the video signals 121, 122 and 123 which have been subjected to the super-resolution coring process.

In the above-described image processing apparatus, the condition in which MPEG noise tends to easily occur can be detected, and when this condition is detected, the effect of the super-resolution coring can be increased, and the image sharpening gain can be decreased. Thereby, without affecting other images, the MPEG noise can be reduced. Specifically, it is possible to prevent degradation in image quality due to the block noise which is peculiar to a digital signal in an image with many moving picture components.

If the above-described image processing apparatus is not applied, for example, the super-resolution coring parameter and image sharpening parameter would remain fixed, and MPEG noise would be emphasized in the condition in which MPEG noise tends to easily occur.

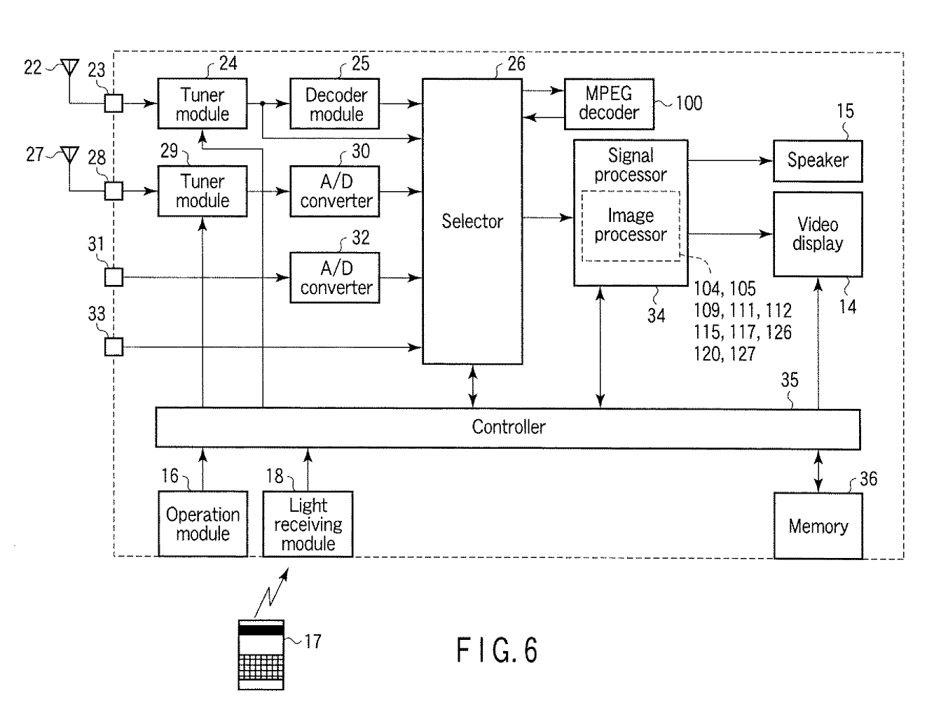

FIG. 6 is a view which schematically shows the structure of a TV signal receiving apparatus in which the image processing apparatus shown in FIG. 1 is incorporated.

As shown in FIG. 6, the TV signal receiving apparatus includes a signal processor 34. The signal processor 34 includes, as an image processor, the image processing apparatus shown in FIG. 1. A digital TV broadcast signal, which is received by an antenna 22 for receiving digital TV broadcast, is supplied to a tuner 24 via an input terminal 23. The tuner 24 selects a signal of a desired channel from input digital TV broadcast signals, and demodulates the selected signal. A signal, which is output from the tuner 24, is supplied to a decoder 25 and is subjected to an MPEG (moving picture experts group) 2 decoding process.

An output signal from the tuner 24 is also supplied to a selector 26. From this signal, video/audio information, for instance, is separated, and the video/audio information may be recorded in a memory via a controller 35.

An analog TV broadcast signal, which is received by an antenna 27 for receiving analog TV broadcast, is supplied to a tuner 29 via an input terminal 28. The tuner 29 selects a signal of a desired channel from input analog TV broadcast signals, and demodulates the selected signal. A signal, which is output from the tuner 29, is digitized by an A/D (analog/digital) converter 30, and a digitized signal is output to the selector 26.

An analog video/audio signal, which is supplied to an input terminal 31 for analog signals, is supplied to, and digitized by, an A/D converter 32, and a digitized signal is output to the selector 26. Further, a digital video/audio signal, which is supplied to an input terminal 33 for digital signals, is directly supplied to the selector 26.

In the case where an A/D converted signal is to be recorded in the memory, the A/D converted signal is subjected to a compression process by a predetermined format, e.g. MPEG (moving picture experts group) 2 format, by an MPEG encoder which accompanies the selector 26, and then the signal is recorded in the memory.

The selector 26 selects one of the four input digital video/audio signals, and supplies the selected signal to the signal processor 34. The signal processor 34 executes a predetermined signal process on the input digital video signal, and causes the processed video signal to be displayed on a video display module 14. As the video display module 14, use is made of a flat panel display which is composed of a liquid crystal display or a plasma display. The signal processor 34 executes a predetermined signal process on the input digital audio signal, and outputs a resultant analog audio signal to a speaker 15, thus performing audio playback.

Various operations of this TV signal receiving apparatus, including the above-described various receiving operations, are comprehensively controlled by the controller 35. The controller 35 is a microprocessor incorporating, e.g. a CPU (central processing unit). The controller 35 processes operation information from an operation module 16 or an operation unit (not shown), or operation information which is transmitted from a remote-controller 17 and is received by a light receiving module 18. Thereby, the controller 35 controls the respective components so as to reflect the operation contents.

In this case, the controller 35 uses a memory 36. The memory 36 mainly comprises a ROM (read-only memory) which stores a control program which is executed by the CPU, a RAM (random access memory) for providing a working area for the CPU, and a nonvolatile memory which stores various setting information and control information.

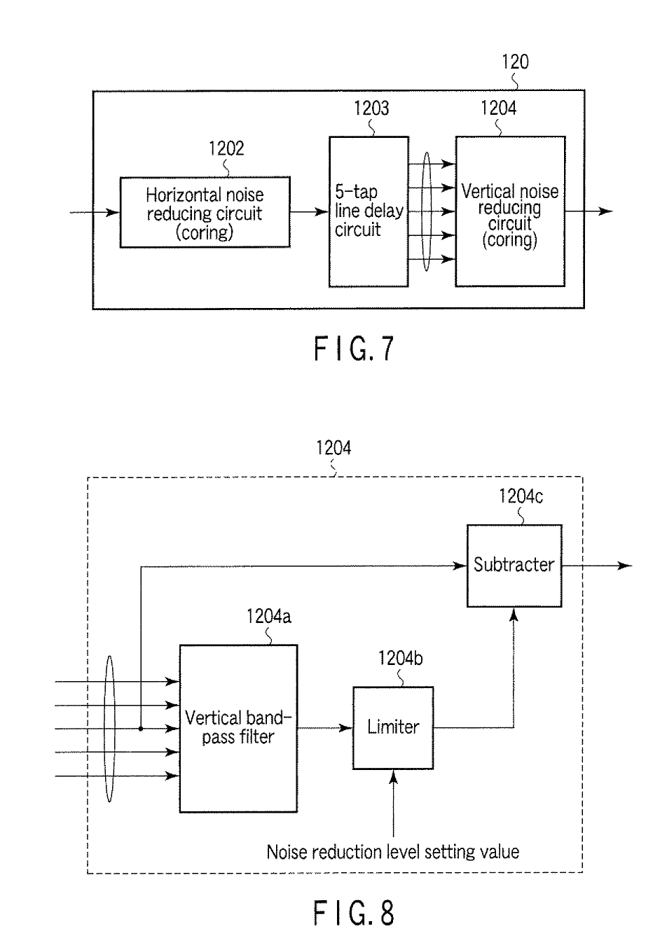

Next, referring to FIG. 7 and FIG. 8, the super-resolution coring process is described. For example, the super-resolution coring processor 120 is configured, as shown in FIG. 7. An input video signal is input to a horizontal noise reducing circuit 1202, a 5-tap line delay circuit 1203 and a vertical noise reducing circuit 1204.

The horizontal noise reducing circuit 1202 is a filter using, for example, a clock delay element and a coefficient unit, and executes a process of reducing noise on horizontal lines in the horizontal direction. An output from the horizontal noise reducing circuit 1202 is input to the 5-tap line delay circuit 1203. The 5-tap line delay circuit 1203 synchronizes 5 horizontal lines by using line delay circuits. The synchronized line signals are input to the vertical noise reducing circuit 1204 and subjected to a noise reducing process for the vertical direction, and the processed signal is output to an output terminal.

The above-described super-resolution coring parameter 119 is input to the horizontal noise reducing circuit 1202 and vertical noise reducing circuit 1204 in order to control the noise reduction amount thereof. The noise reduction level of the horizontal noise reducing circuit 1202 is controlled on the basis of the super-resolution coring parameter 119, and the noise is reduced by a coring process of a high-region component in the horizontal direction. In addition, the noise reduction level of the vertical noise reducing circuit 1204 is controlled on the basis of the super-resolution coring parameter 119, and the noise is reduced by a coring process of a high-region component in the vertical direction.

FIG. 8 is a view showing an example of the vertical noise reducing circuit 1204 shown in FIG. 7. A signal from the 5-tap line delay circuit 1203 is input to a vertical band-pass filter 1204a. The vertical band-pass filter 1204a executes a filtering process by using the input signal, and extracts a vertical high-region component including a noise component. This vertical high-region component is input to a limiter 1204b and is subjected to, for example, amplitude limitation by the super-resolution coring parameter 119. An output from the limiter 1204b is input to a subtracter 1204c. The subtracter 1204c subtracts the output of the limiter 1204b from the signal of the center tap of the line delay output signal, and the noise that is the vertical high-region component is reduced. Thereby, a video signal, in which noise is reduced by the high-region coring method, can be obtained from the subtracter 1204c. The magnitude of the amplitude of the output of the limiter 1204c becomes the degree of noise reduction.

The various modules of the systems described herein can be implemented as software applications, hardware and/or software modules or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An image processing apparatus comprising:
a detector configured to detect a difference value between frames included in image data;
a sharpening parameter setting module configured to set a sharpening parameter for controlling a sharpening effect gain for the image data in accordance with the detected difference value; and
a sharpening processor configured to perform a sharpening process to the image data based on the sharpening parameter.

2. An image processing apparatus comprising:
a detector configured to detect a difference value between frames included in image data;
a coring parameter setting module configured to set a coring parameter for controlling a coring effect for the image data, in accordance with the detected difference value; and
a coring processor configured to perform a coring process to the image data based on the coring parameter.

3. The apparatus of claim 1, further comprising:
a coring parameter setting module configured to set a coring parameter for controlling a coring effect for the image data, in accordance with the detected difference value; and
a coring processor configured to perform a coring process to the image data based on the coring parameter.

4. The apparatus of claim 1, wherein the sharpening parameter setting module is configured to set a first sharpening parameter for obtaining a first sharpening effect gain based on detection of a first difference value, and to set a second sharpening parameter for obtaining a second sharpening effect gain, which is less than the first sharpening effect gain, based on detection of a second difference value which is greater than the first difference value, and
the sharpening processor is configured to perform the sharpening process to the image data based on either the first or second sharpening parameter.

5. The apparatus of claim 3, wherein the sharpening parameter setting module is configured set a first sharpening parameter for obtaining a first sharpening effect gain based on detection of a first difference value, and to set a second sharpening parameter for obtaining a second sharpening effect gain, which is less than the first sharpening effect gain, based on detection of a second difference value which is greater than the first difference value, and
the sharpening processor is configured to perform the sharpening process to the image data based on either the first or second sharpening parameter.

6. The apparatus of claim 2, wherein the coring parameter setting module is configured to set a first coring parameter for obtaining a first coring effect based on detection of a first difference value, and to set a second coring parameter for obtaining a second coring effect, which is greater than the first coring effect, based on detection of a second difference value which is greater than the first difference value, and
the coring processor is configured to perform the coring process to the image data based on either the first or second coring parameter.

7. The apparatus of claim 3, wherein the coring parameter setting module is configured to set a first coring parameter for obtaining a first coring effect based on detection of a first difference value, and to set a second coring parameter for obtaining a second coring effect, which is greater than the first coring effect, based on detection of a second difference value which is greater than the first difference value, and
the coring processor is configured to perform the coring process to the image data based on either the first or second coring parameter.

8. The apparatus of claim 1, wherein the sharpening parameter setting module is configured to set a first threshold and a second threshold which is higher than the first threshold, to set a first sharpening parameter for gaining a first sharpening effect gain based on detection of a first difference value which is less than the first threshold, to set a second sharpening parameter for gaining a second sharpening effect gain, which is less than the first sharpening effect gain, based on detection of a second difference value which is greater than the second threshold, and to set a third sharpening parameter for obtaining a third sharpening effect gain which is less than the first sharpening effect gain and greater than the second sharpening effect gain, the third sharpening effect gain decreasing in accordance with an increase of a third difference value, based on detection of the third difference value which is between the first threshold and the second threshold, and
the sharpening processor is configured to perform a sharpening process to the image data based on the first, second or third sharpening parameter.

9. The apparatus of claim 3, wherein the sharpening parameter setting module is configured to set a first threshold and a second threshold which is higher than the first threshold, to set a first sharpening parameter for gaining a first sharpening effect gain based on detection of a first difference value which is less than the first threshold, to set a second sharpening parameter for gaining a second sharpening effect gain, which is less than the first sharpening effect gain, based on detection of a second difference value which is greater than the second threshold, and to set a third sharpening parameter for obtaining a third sharpening effect gain which is less than the first sharpening effect gain and greater than the second sharpening effect gain, the third sharpening effect gain decreasing in accordance with an increase of a third difference value, based on detection of the third difference value which is between the first threshold and the second threshold, and
the sharpening processor is configured to perform a sharpening process to the image data based on the first, second or third sharpening parameters.

10. The apparatus of claim 2, wherein the coring parameter setting module is configured to set a first threshold and a second threshold which is higher than the first threshold, to set a first coring parameter for gaining a first coring effect based on detection of a first difference value which is less than the first threshold, to set a second coring parameter for gaining a second coring effect, which is greater than the first coring effect, based on detection of a second difference value which is greater than the second threshold, and to set a third coring parameter for obtaining a third coring effect which is greater than the first coring effect and less than the second coring effect, the third coring effect increasing in accordance with an increase of a third difference value, based on detection of the third difference value which is between the first threshold and the second threshold, and
the coring processor is configured to perform a coring process to the image data based on the first, second or third coring parameters.

11. The apparatus of claim 3, wherein the coring parameter setting module is configured to set a first threshold and a second threshold which is higher than the first threshold, to set a first coring parameter for gaining a first coring effect based on detection of a first difference value which is less than the first threshold, to set a second coring parameter for gaining a second coring effect, which is greater than the first coring effect, based on detection of a second difference value which is greater than the second threshold, and to set a third coring parameter for obtaining a third coring effect which is greater than the first coring effect and less than the second coring effect, the third coring effect increasing in accordance with an increase of a third difference value, based on detection of the third difference value which is between the first threshold and the second threshold, and
the coring processor is configured to perform a coring process to the image data based on the first, second or third coring parameters.

12. The apparatus of claim 1, further comprising a tuner configured to select a signal of a desired channel from broadcast signals,
wherein the detector is configured to detect a difference value between frames included in image data in the selected signal.

13. An image processing method comprising:
detecting a difference value between frames included in image data;
setting a sharpening parameter for controlling a sharpening effect gain on the image data, in accordance with the detected difference value; and
performing a sharpening process to the image data based on the sharpening parameter.
